(19) United States
(12) Patent Application Publication
(10) Pub. No.: US 2012/0051643 A1
(43) Pub. Date: Mar. 1, 2012

(54) METHOD AND SYSTEM FOR CAPTURING AND INVENTORING RAILCAR IDENTIFICATION NUMBERS

(75) Inventors: Hung Ha, Houston, TX (US); Hoa Ha, Houston, TX (US)

(73) Assignee: E. I. Systems, Inc., Houston, TX (US)

(21) Appl. No.: 12/868,131

(22) Filed: Aug. 25, 2010

(51) Int. Cl. G06K 9/20; G06K 9/18

(52) U.S. Cl. 382/182; 382/321

(57) ABSTRACT

The present invention is a method and system that automates the process of locating and identifying railcars in a rail yard. The method and system of this invention creates an electronic record of a railcar identification number that is stenciled to the side of the railcar using digital camera technology and an Optical Character Recognition (OCR) device and software applications. The method and system of the present invention eliminates the need for using the AEI portable reader.

### FIELD OF THE INVENTION

This invention relates to identifying railcars and railcar locations in rail yards and in particular to a method and system for identifying the location of a railcar in a rail yards based on the railcar identification number stenciled to the railcar. This invention uses a digital camera device to capture the image of a stenciled railcar identification number and optical character recognition techniques convert the captured image into an electronic format of the railcar identification number for processing.

### BACKGROUND OF THE INVENTION

A freight train comprises a group of freight cars or railcars hauled by one or more locomotives on a railway or train track. These railcars transport cargo between points as part of the system of transporting goods.

A rail yard or railroad yard is a complex series of railroad tracks for storing, sorting or loading and unloading railroad cars and locomotives. Rail yards have many tracks in parallel for keeping rolling stock stored off the main railroad lines, so that they do not obstruct the flow of rail traffic. Cars in a rail yard may be sorted by numerous categories, including a particular railroad company, loaded or unloaded cars, car type or commodity or whether the cars need repairs. Rail yards are normally built where there is a need to store cars while they are not being loaded or unloaded, or are waiting to be assembled into trains.

Rail yards may have dozens or even hundreds of tracks and may contain hundreds to thousands of rail cars. The large number of railcars in a rail yard and the constant entry and exit of railcars requires an efficient inventory system to manage and track all of the activities associated the railcars in a rail yard. The railcar management activities include identifying and tracking the number locations and history of the railcars in the rail yard. Since a rail yard has multiple tracks, cars can be on any given track and could be in any position on that track. Precise and real time knowledge of the location of each railcar is critical to effective rail yard management.

A primary method for performing rail yard inventory and management of railcars is through the use of RFID technology. In this method, radio frequency tags are attached to each car. Radio-frequency identification (“RFID”) tag technology is very popular for use in inventory tracking systems. A RFID tag contains a non-volatile memory for storing information identifying the object or location and electronic circuitry for interacting with an interrogator to transmit that information to the interrogator device. RFID tags may be passive or active. In the case of a passive RFID tag, the tag includes circuitry for converting at least a portion of the received RF signals into electrical power needed by the tag for signal processing and signal transmission. In a typical RFID tag system, RFID tags containing information associated with the identities of inventory items to be tracked are attached to the inventory items. An RFID interrogator detects the presence of an RFID tag and reads the identification information from the tag. A typical RFID interrogator includes an RF transceiver for transmitting interrogation signals to and receiving response signals from RFID tags, one or more antennae connected to the transceiver, and associated decoders and encoders for reading and writing the encoded information in the received and transmitted RF signals, respectively. The interrogator may be a portable device, which can be brought near the tags to be read, or it may be a stationary device, which reads the tags as they are brought to the interrogator, as in the case of tagged library books being returned to a return station that is fitted with an interrogator. RFID tags may also be affixed near a location as a location marker. After detecting both a tag attached to an inventory item and a location marking tag, a processing unit associated with the interrogator may determine that the inventory item is positioned near the tagged location. While these conventional object tracking systems are capable of keeping a record of the inventory items and sometimes their locations, they are not effective for tracking and/or managing the movement of the inventory items.

With regards to RFID technology applications related to railcar use, an RFID tag is affixed to a railcar. The RFID tag contains the identification number for that particular railcar. This identification number also appears as a visible number painted on the railcar. As shown in FIG. 1, a rail yard has multiple railroad tracks 102. Each track can have multiple railcars 104. These cars can be connected to each other or just positioned adjacent each other on the track. Each railcar has an identification number 106 stenciled to the side of the car. This number is visible and humanly readable. Today, railcars also have this identification number programmed and stored in an RFID tag affixed to the railcar 104. As part of the inventory tracking system used today, a rail yard entrance can have a booth 108 that contains an RFID tracking device 110 that sends out a radio frequency signals 112 and detects the RFID signals of the railcar's tags as they enter the rail yard. Video cameras are also used in some instances to record railcars entering a rail yard. In addition, a rail yard can have a booth 114 at the exit of the rail yard. This booth can also have an RFID detection device 116 that generates radio frequency signals 118 to detect RFID signals from railcars exiting the rail yard. Again, this configuration at the exit of the rail yard helps determine whether a railcar has left the rail yard. Some locations have only one booth 108 and it can be utilized as entrance and exit.

A similar RFID technology is deployed to document the location of individual cars within a rail yard, such as at loading/unloading locations or at scale house. A mobile RFID handheld reader carried by a person who walks or rides alongside each track is used to read the RFID tag on each railcar based on selected track and selected yard. An application in the handheld records railcar ID and generates a sequential list of the cars and location per scanned track. This process can be duplicated for the next track in the rail yard. Similarly, rail cars which have been moved to a new track during the course of business can be scanned with a mobile RFID handheld reader.

Although this RFID approach is the most popular one in current use, this approach still has some limitations. This method of transmitting an RF signal from an RFID tag affixed to a railcar requires the use of a special RFID reader device. Individuals performing inventory management procedures move through a rail yard with an RFID detector device detecting railcar identification numbers that are used in the inventory management process. Without the use of the RFID device, one cannot implement the RFID method for identifying and verifying railcar numbers. The use of RF tags for identification of products is implemented in many applications including several applications related to inventory management and control, however, there remains a need for a more flexible and automated system for capturing, transmitting and processing railcar numbers for railcar inventory applications.

### SUMMARY OF THE INVENTION

The present invention automates the process of locating and identifying railcars in a rail yard. The method and system of this invention creates an electronic record of a railcar identification number using any form of Optical Character Recognition (OCR) device and software application.

In the method of this invention, rail yard personnel (the user) can use a camera device such as a camera telephone to take pictures (images) of the railcar number stenciled on the railcar. The camera device can be used to take pictures (images) of the railcar number stenciled on the side of the car. The application then can process the image on the phone device or transmit the image in the form of a message with the same camera phone, to a system server for processing. In either approach, images are processed to extract the railcar number and any other desired information utilizing the OCR technology. After the rail car image is successfully converted, user then enters other railcar associated information, such as car status, content, seal code, or loading spot number. When the last car is processed, camera application will send a list of railcars and its associated information to server for processing. The server will convert the list of railcars to common format, import to database, process data, create customized reports (T94, CSV, EDI, train consist, . . . ) based on Client's specification, and finally send reports to Client and Client's customer.

In the method of the invention, the user can sequentially capture a series of images for multiple railcars. Depending on the capabilities of the particular camera device, the OCR capabilities may be contained in the camera device or on the server.

The use of a captured railcar identification number image from a camera provides more flexibility than the conventional use of RFID tags and RFID detection devices. For implementation of the method of the present invention, several digital camera type devices can perform the image capturing operation.

### DESCRIPTION OF THE DRAWINGS

FIG. 1 is a conventional view of railcars entering and exiting a rail yard and the capturing of railcar identification as railcars enter and exit the rail yard.

FIG. 2 is a configuration of multiple rail tracks and multiple railcars on the multiple rail tracks in a rail yard.

FIG. 3 is a configuration of the software components in the implementation of the present invention.

FIG. 4a is a format of a record used to track the location of a railcar in a rail yard.

FIG. 4b is an example of railcars on a track in a rail yard.

FIG. 4c is an example of an actual record listing the location information of a railcar in a rail yard.

FIG. 5 is a view of the general steps in the implementation of the method of the present invention.

FIG. 6 is a view of the user steps in the implementation of the method of the present invention when OCR processing occurs at the server.

FIG. 7 is a view of the server steps in the implementation of the OCR conversion method of the present invention.

FIG. 8 is a view of the server steps in the implementation of the processing of a list of railcar numbers received from an electronic camera device.

FIG. 9 is a view of the user steps in the implementation of the present invention when OCR processing occurs in the electronic camera device.

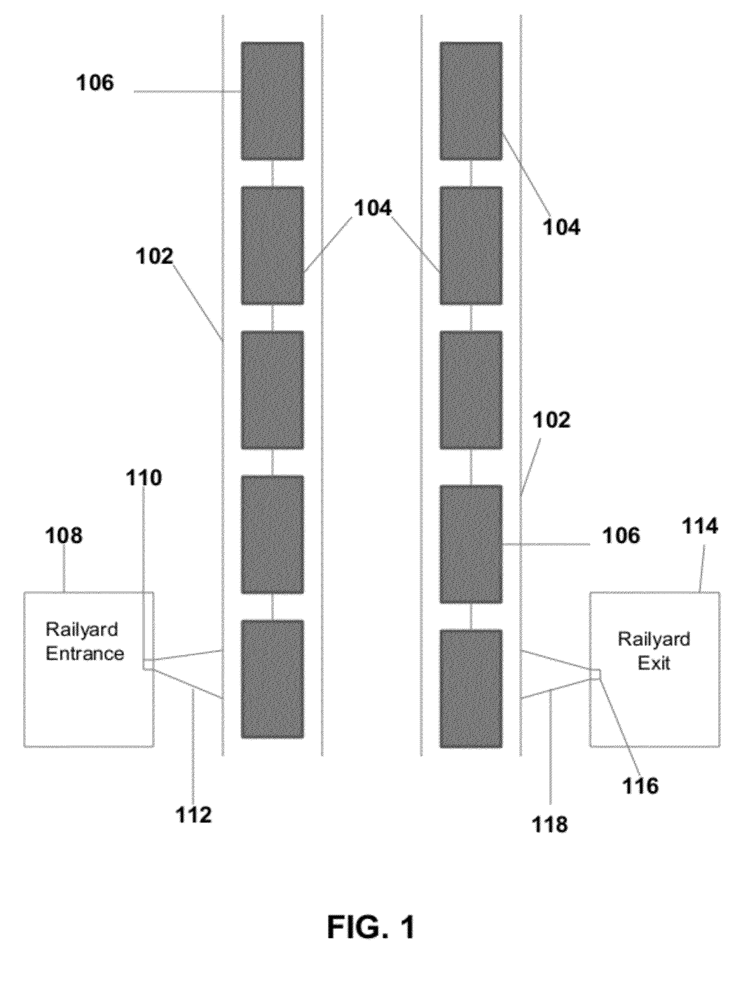

### DETAILED DESCRIPTION OF THE INVENTION

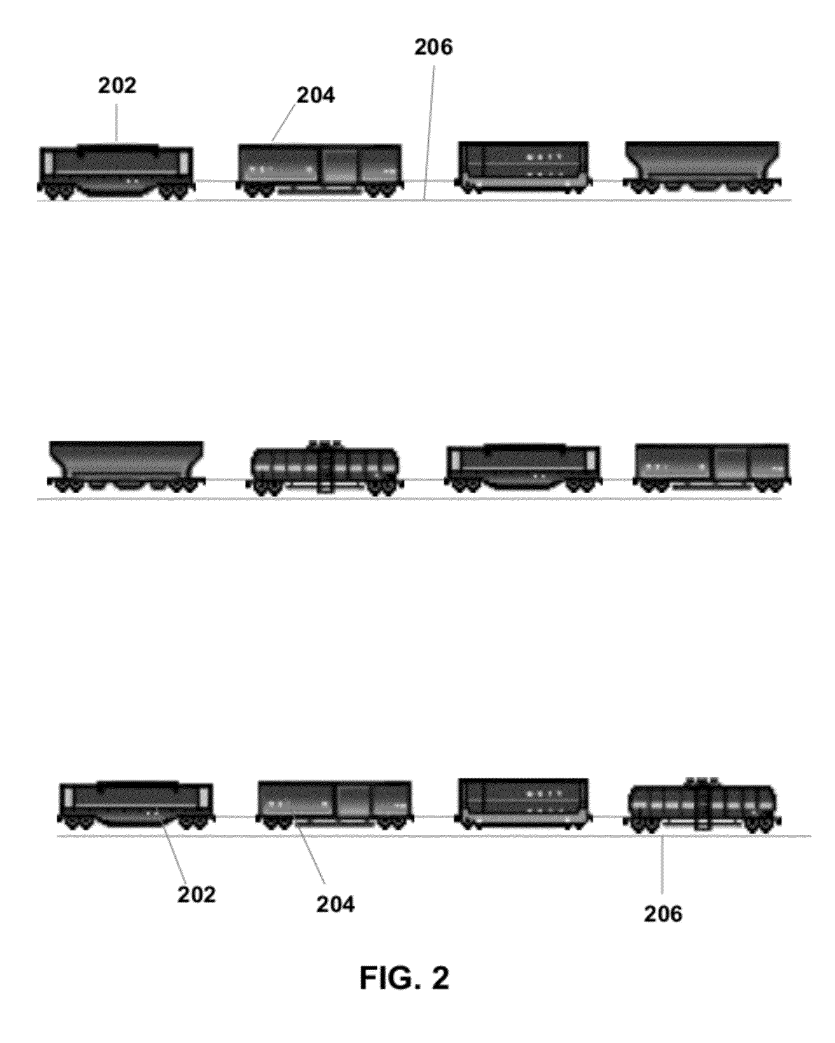

Rail yards contain numerous railcars. FIG. 2 shows a configuration of railcars at a rail yard. As shown, multiple railcars 202 are positioned on a rail track 206. Each railcar has an identification number 204 stenciled to it. These numbers are in clear view with the human eye. An RFID tag affixed to a railcar also has this number programmed into it.

Each track contains several railcars. In some instances, one railcar connects to other railcars. In other instances, a railcar may be isolated or connected to only other railcar. Regardless of the configuration and railcar connection, each railcar in a rail yard should be identified and located. The rail yard manager performs inventory activities and produces a report of railcars, rail track locations and connects of a railcar to other railcars. Considering the number of railcars that can be in a rail yard, the task of managing the rail yard can be a challenging one.

As previously mentioned, in the method of this invention, rail yard personnel can uses a camera device such as a camera telephone to take pictures (images) of the railcar number stenciled on the railcar. The same device can be used to take pictures (images) of the yard Id, the track ID, delivery ID, scale ID any other photographic evidence that the user desires to collect.

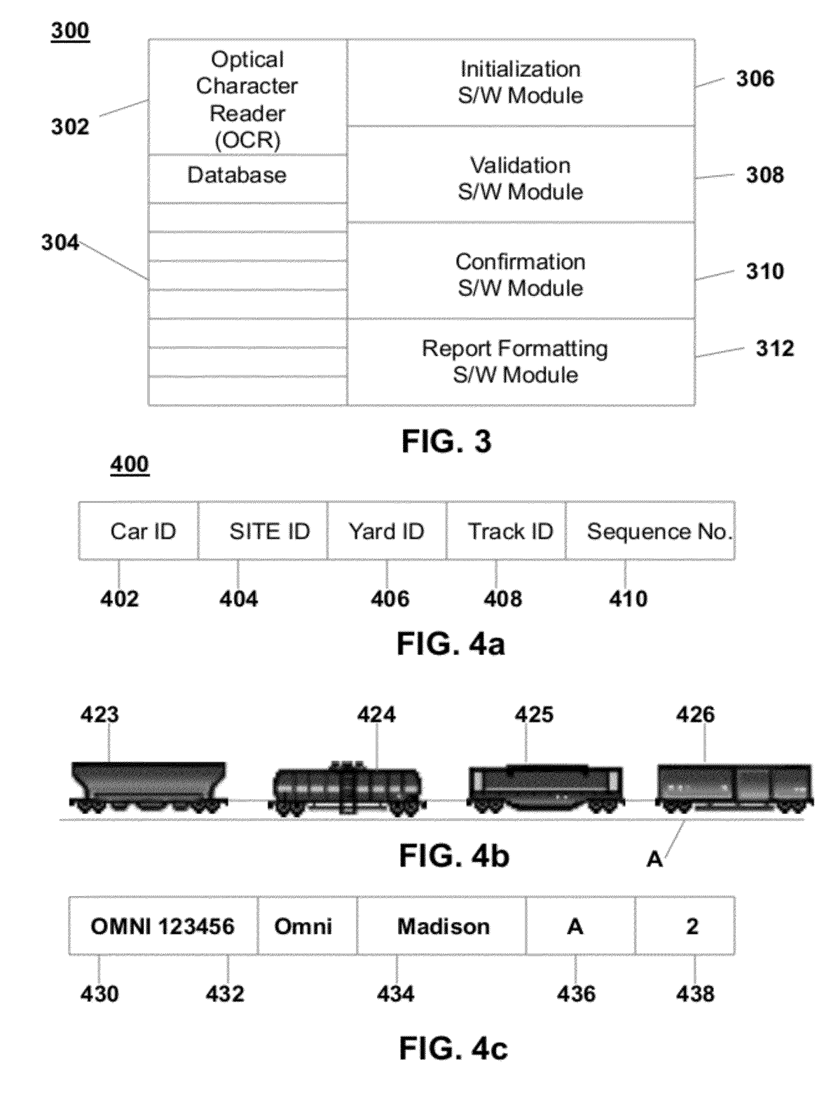

FIG. 3 shows a configuration 300 of the various software modules and database that performs the implementation of the method of the present invention. There are various embodiments for these software components. The optical character reader (OCR) 302 receives the picture image taken by the camera device and converts that number captured in that image into an electronic version of that number. This electronic number can now be processed in a manner similar to the RFID number generated from the RFID tag. The database 304 contains information about each railcar including the railcar identification number, owner status present position in the rail yard and other device information. The information is stored in and retrieved from the database during the processing activities of the present invention. Modules 306, 308, 310 and 312 implement the processing activities of this invention. Module 306 initializes the routines that will processes. Module 306 receives a queue which is an indication that data from an image is coming in for processing. This module performs activities associated with initializing or ‘bringing up’ the system. This module initially receives the converted image from the OCR. Once the converted image has been received, a validation routine in the validation module 308 validates that the received number is a valid number. For example, there may be an image of a railcar number, but the last character of the railcar number was covered by dirt or the OCR did not accurately process the information. Validation may be accomplished by comparing the railcar numbers generated by the conversion process against a known list of valid numbers. The confirmation module 310 confirms back to the user that the railcar number image has been processed and validated, or that the process did not succeed and must either be repeated or that the manually data entered into the system is required. The report formatting module 312 generates a report based on predefined parameters and format defined by a client. For example, a client may want to have a customized reports (T94, CSV, EDI) to show what railcars are on track ‘A’. This module performs processing to collect data from the currently captured, converted images, and store information in the database. This module compiles the information into a report for the specific owner making the request.

FIG. 4a is an illustration of a format for a record 400 for information captured using the camera device. These records 400 are created and stored in a database and can be used to generate reports for various clients. The report can contain various types of information as designated by a particular client that will receive the information. The record format 400 has various fields for railcar information. These fields can include the railcar identification number 402, the railcar owner information represented by the designation SITE identification 404, the rail yard identification 406, the rail yard track number 408 and the railcar sequence number 410. Records for railcar and rail yard information can include other fields in addition to these fields or replace of various fields. FIG. 4b illustrates a set of railcars on a track in a typical rail yard. As shown, this set of railcars comprises four cars 423, 424, 425, and 426. FIG. 4c shows a created record for the railcars in FIG. 4b. This record shows that the railcar ID is for car 424 is ‘OMMI 123456’. The railcar owner is Omni shown in the SITE ID field. The rail yard where the railcar is located is the Madison rail yard. Railcar 424 is located on track ‘A’. The last field reveals that railcar 424 is the second railcar in the sequence of cars. In a rail yard with many tracks and hundreds to thousands of cars, the present invention can generate a report that will tell a railcar owner, how many cars that owner has at a particular rail yard and the location of each railcar at the yard.

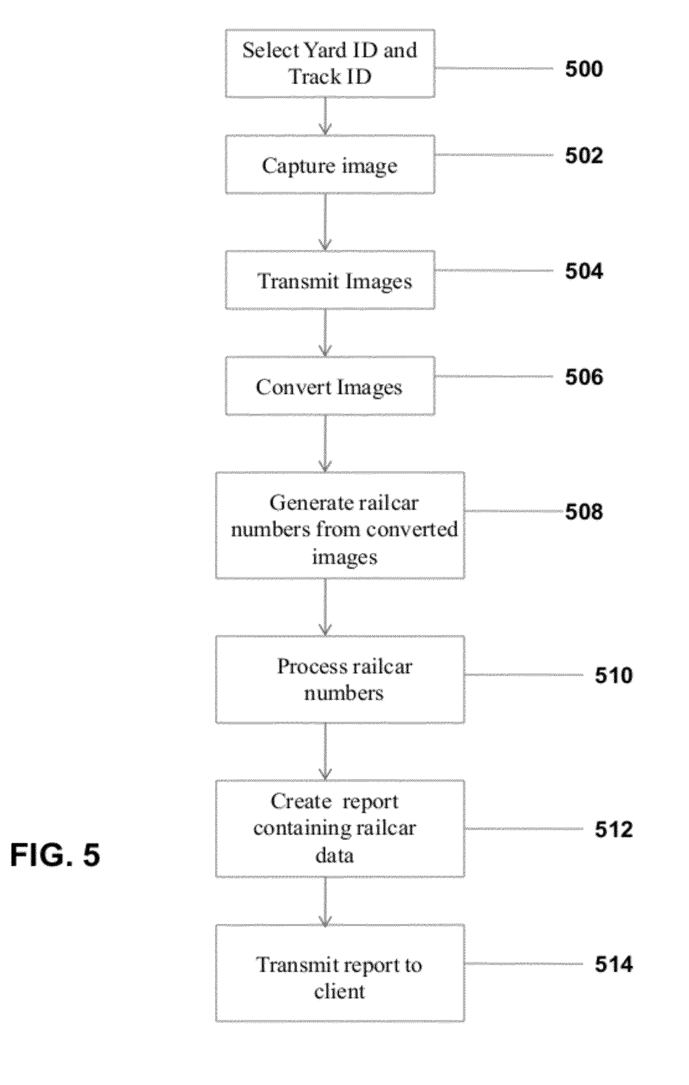

FIG. 5 is a view of the general steps in the implementation of the method of the present invention. The method begins by selecting a yard ID and a track id in step 500, then capturing images of a railcar identification numbers in step 502. Step 504 transmits these images to OCR engine at server or in the camera phone device. The OCR engine converts these images into electronic text in step 506. From this text, step 508 generates a railcar identification numbers corresponding to the numbers captured in the images in step 502. The software in step 510 processes the generated identification numbers. The processing involves the validation and confirmation of the generated numbers. Software in step 512 creates report containing these numbers based on previously defined criteria such track number, and car sequence number and time/date of the image. Last, step 514 creates a report for each completed track which can be transmitted to other systems for further processing.

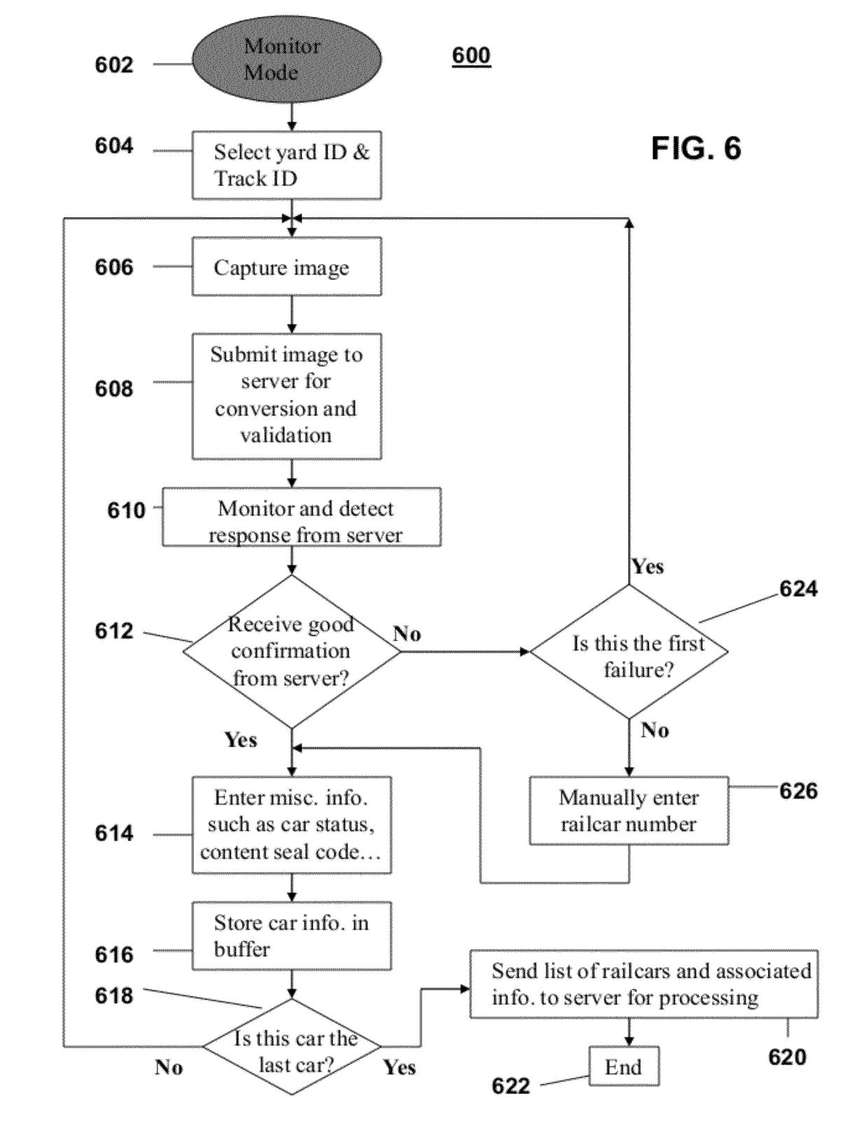

FIG. 6 is a flow diagram of the steps in the implementation of the present invention from the user or camera phone device side. These steps will be implemented in the camera device application with OCR engine reside on the server. The method on the user side 600 begins with the program begin initialized in step 602. In step 604, the user/railcar personnel identifies a rail yard and track. These identities are recorded in the camera phone device. In step 606, the user then captures a railcar number image with an electronic camera device such as a camera telephone. After the identification of the rail yard and the capturing of the railcar number, in step 608, the captured railcar image are transmitted to the server device for conversion of the image and the validation of the a railcar number from the converted image. Once the server receives the transmitted images, the method at the user location goes into a monitor mode in step 610. In this monitor mode, the method at the user end waits for a response from the server regarding the confirmation of the transmitted image.

In step 612, the method at the user end receives a confirmation message from the server. Step 612 also interprets the received message and makes a determination of whether the message is a good confirmation message from the server of a good conversion of the image into a valid text of the number of the railcar. If the determination is that the conversion is a good conversion. When the determination is that the conversion is a good conversion, the method moves to step 614 where the user enters additional information about the railcar that corresponds to the converted railcar number. Step 616 stores the enter information in a buffer at the electronic camera device location. The next step 618 queries the user to determine if the last transmitted railcar was the last railcar to be submitted by the user. When the determination based on the user's response in step 618 is that the last submitted railcar image was the last railcar, the method moves to step 620 which sends the list of railcars and associated information to the server for processing. The method then determinates in step 622. When the determination in step 618 is that the last railcar entered was not the last railcar, then the method moves back to step 606 where the user captures the image for the next railcar.

Referring back to step 612, when the determination is that the conversion was not a good conversion of the image, the method moves to step 624 which queries the user to determine whether this is the first failure. If this is not the first failure, then the method moves to step 626 in which the user manually enters the railcar number. After manually entering the railcar number, the method moves to step 614 where the user enters the additional information about the specific railcar corresponding to the manually entered railcar number. If in step 624 this is the first failure, then the method moves to step 608 where the recaptured image is transmitted to the server for conversion and confirmation of the railcar image.

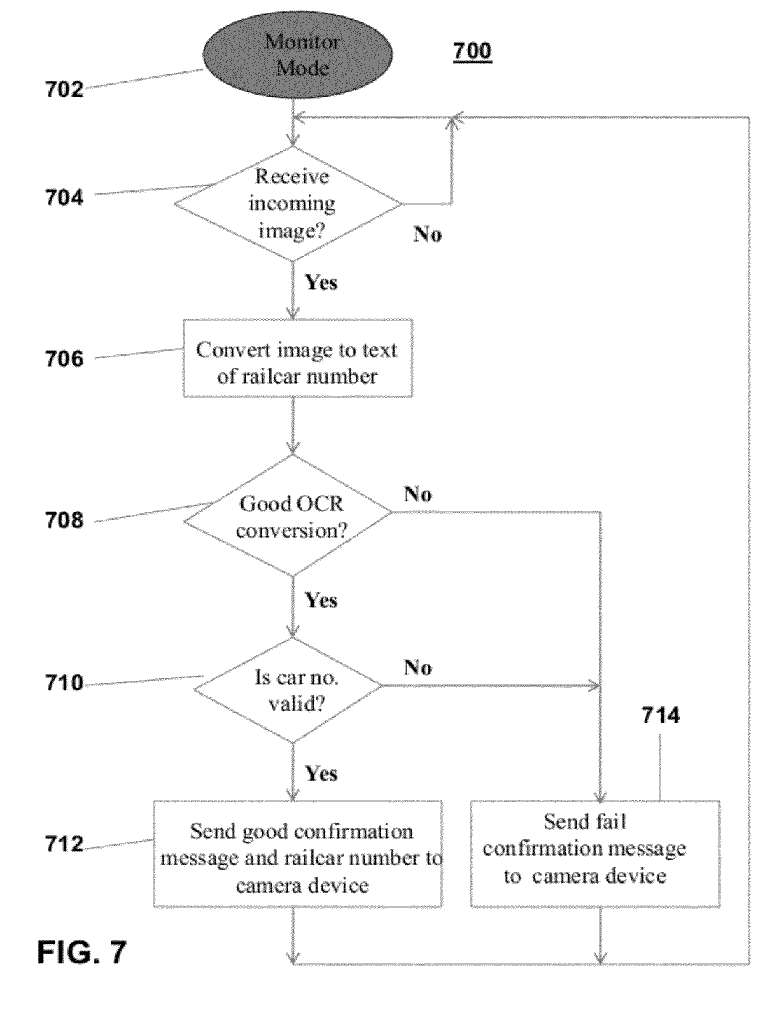

FIG. 7 describes the validation of OCR conversion process 700 of a railcar number contained in a captured image transmitted to a server from a user. This process at begins with step 702 which initialized the process. Once initialized, the process moves to step 704 which is a monitor state and waits for an incoming message containing a captured image. In this monitoring state, there can be period checks to determine if an image message had been sent to the server. If during the period check, the determination is that no message is waiting, the method returns to the monitor state. When an incoming message is received at the server, step 706 converts the image containing the railcar number to text using the OCR technology. Step 708 makes a determination of whether the OCR conversion was a good conversion. If the conversion in step 708 is a good conversion (the conversion produced a legible string of numbers), the method moves to step 710 which validates the number based on the valid railcar numbers stored in a database. The validation can be a process of matching the converted number with valid numbers in the database. If step 710 was able to validate the converted number, step 712 sends a good conversion confirmation message to the user which is received by the electronic camera device at the user location. Referring back to step 708, if the conversion is not good, the method moves to step 714 which sends a fail confirmation message back to the electronic camera device at the user location. Also, in step 710, if the validation process fails to validate the converted railcar number, the method moves to step 714 which sends a fail confirmation to the electronic camera device at the user location. At this point, the method of FIG. 6 continues at step 614.

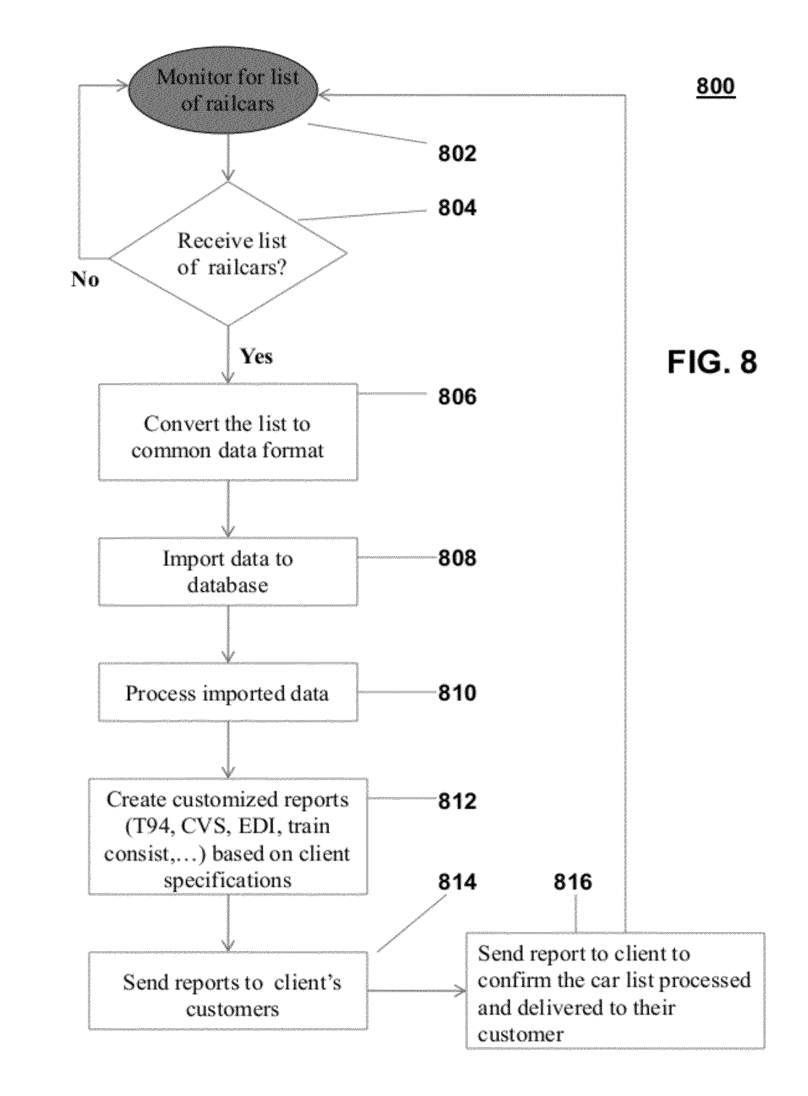

FIG. 8 is a flow diagram of the steps in implementing the method of present invention when the server receives the list of railcars and associated information that received from camera device. This list is the information produced in the method descried in FIG. 6. This method 800 begins with the method being in a monitor mode 802 waiting to receive a list of railcars. Step 804 can be a period check to determine if there has been a transmission of a railcar list from the electronic camera device of the user. If the check does not reveal that a transmitted list, the method continues in the monitor mode of step 804. If the period check shows that the user has transmitted a railcar list, the method moves to step 806 which converts the information in the list to a common data format. Step 808 imports the information in the common form to the database for processing and storage. The imported data is processed in step 810 and is integrated with other systems, such as yard management systems, to keep track of rail cars on customer's site. Step 812 creates a customized report (i.e. T94, CSV, EDI, train contents . . . ) based on the specifications of the client. In step 814, the report is sent to the client's customers. Step 816 sends a copy of the report to the client to confirm the railcar list processed and delivered to the client's customer. After the method sends the report to the client in step 816, the method returns to the monitor mode in step 802.

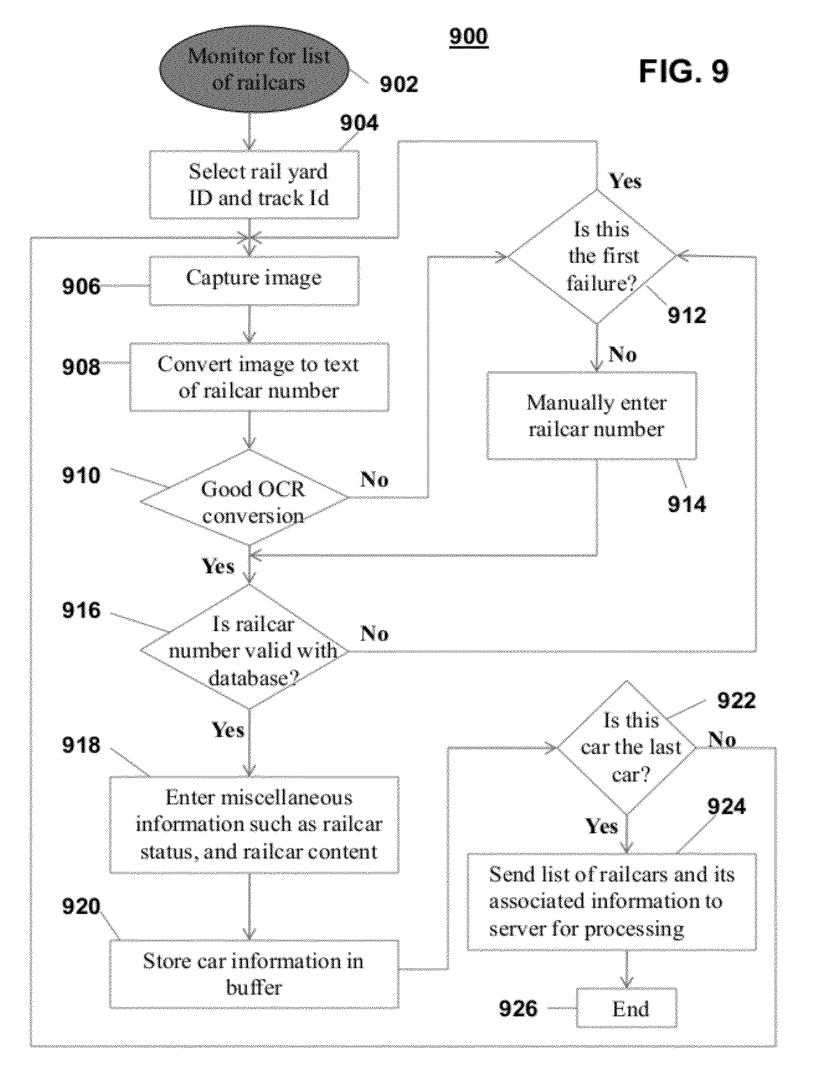

FIGS. 6, 7 and 8 describe a method in which one part of the process occurs in the electronic camera device operated by the user and captures a railcar image, the other part of the method is implemented in the server. In FIG. 9, the processing of captured images in the method of the present invention can be accomplished in the camera device without the need to transmit the images to server. This method is similar to the method of FIG. 6 but without the steps to transmit the images to sever prior to processing.

The method 900 is initialized in step 902. Once the method is initialized, the user identifies a rail yard in step 904. In step 906, the user captures an image of a railcar number. This captured image is converted to a text number in step 908 using the OCR technology. Step 910 confirms whether the conversion is good or not. The confirmation can be a set of parameters such as a set number of legible characters in the converted image. If this number of converted characters is not legible, the confirmation would fail. If the conversion confirmation fails, the method moves to step 912 which queries the user and determines whether this is the first failure. If this is not the first failure then user manually enter the railcar number, the method moves to step 914. After the manual entry of the railcar number, the method moves to step 916. Referring back to step 912, if this is the first failure then user moves to step 906 and recaptures the railcar number image.

In step 916, the method determines whether the railcar number is valid by comparing it to the valid railcar numbers in the database. If the determination is that the captured railcar number is not valid, the method again moves to step 912 and continues from that step. If the determination in step 916 is that the railcar number is valid, in step 918, the user inputs additional information such as railcar content or railcar status. Step 920 stores the information for the particular railcar in a buffer location in the electronic camera device. Step 922 determines whether the current railcar number being processed is the last car in the sequence. If the current railcar is the last railcar in the list, the processed information that is stored in the buffer location in step 920 is sent to the server location for processing in step 924. At this point, step 926 ends the method. If in step 922, the current railcar number is not the last car, the method returns to step 906 which captures the next railcar number.

As mentioned, the method and system described in the present invention improves the process of identifying, transmitting and verifying railcar identities and locations for rail yard inventory activities. The present invention incorporates digital camera and optical character recognition technologies that make the identification process more flexible and does not tie the automated process of railcar identification and verification exclusively to the implementation of RFID technology.

While the present invention has been illustrated by the description of embodiments thereof, and while the embodiments have been described in some detail, it is not the intention of the applicant to restrict or in any way limit the scope of the appended claims to such detail. Additional advantages and modifications will readily appear to those skilled in the art. The invention in its broader aspects is not limited to the specific details, representative apparatus and methods, and illustrative examples shown and described. Accordingly, departures may be made from such details without departing from the spirit or scope of the applicant's general inventive concept.

We claim:

1. A system for capturing railcar identification number images and converting the capture images into electronic text comprising:
an electronic camera device for capturing an image of a railcar identification number affixed to a railcar, said camera device capable of transmitting an image;
an optical character recognition module in communication with said electronic camera device for converting contents of the captured image into electronic text of the captured railcar number affixed to a railcar;
a software module for validating the electronic text of the captured railcar number affixed to a railcar; and
a software module for formatting a report or file based on the converted railcar numbers and based on predefined parameters.

2. The system as described in claim 1 where said computing device for receiving a transmitted image from said electronic camera device comprises a server device in communication with said electronic camera device via a communication network.

3. The system as described in claim 1 wherein said electronic camera device is a camera telephone.

4. The system as described in claim 1 wherein said optical character recognition module is contained within said server.

5. The system as described in claim 1 wherein said optical character recognition module is contained in the electronic camera device.

6. A method for capturing railcar identification number images and converting the captured images into electronic text comprising:
capturing images of railcar numbers affixed to a railcar using an electronic camera device;
converting the captured images into electronic text at the optical character recognition processor;
generating a railcar number from each electronic text conversion;
confirming that the generated railcar numbers are valid railcar numbers; and
formatting a report based on the converted railcar numbers and based on predefined parameters.

7. The method as described in claim 6 further comprising before said capturing an image of a railcar number affixed to a railcar, creating a database of valid railcar numbers, valid truck numbers, and valid cellular telephone numbers.

8. The method as described in claim 6 wherein said railcar confirmation further comprising:
retrieving the railcar image;
determining whether the sender of the image is a valid sender;
when the determination is that the sender of the image is a valid sender, determining whether the converted image is a readable image;
when the determination is that the image is a readable image, comparing that image to valid railcar numbers stored in said database;
determining whether there is a match between the captured image and a valid railcar number in the data.

9. The method as described in claim 6 further comprising before said converting step, the step of transmitting the captured images to an optical character recognition processor;

10. The method as described in claim 9 wherein said transmitting step further comprising packaging a sequence of images and transmitting the package of images.

11. The method as described in claim 6 wherein said image capturing step further comprises capturing additional information in an image of the railcar, said additional information can comprise, track number and sequence number of a railcar.

12. A computer program product in a computer readable storage medium for capturing railcar identification number images and converting the captured images into electronic text comprising:
instructions capturing images of railcar numbers affixed to a railcar using an electronic camera device;
instructions converting the captured images into electronic text at the optical character recognition processor;
instructions generating a railcar number from each electronic text conversion;
instructions confirming that the generated railcar numbers are valid railcar numbers; and
instructions formatting a report based on the converted railcar numbers and based on predefined parameters.

13. The computer program product as described in claim 12 further comprising before said instructions capturing an image of a railcar number affixed to a railcar, instructions creating a database of valid railcar numbers, valid truck numbers, and valid cellular telephone numbers.

14. The computer program product as described in claim 12 wherein said image capturing instructions further comprise instructions capturing additional information in an image of the railcar, said additional information can comprise, track number and sequence number of a railcar.

15. The computing program product as described in claim 12 wherein said railcar confirmation instructions further comprise:
instructions retrieving the transmitted railcar image;
instructions determining whether the sender of the image is a valid sender;
when the determination is that the sender of the image is a valid sender, instructions determining whether the converted image is a readable image;
when the determination is that the image is a readable image, instructions comparing that image to valid railcar numbers stored in said database; and
instructions determining whether there is a match in between the captured image and a valid railcar number in the data.
